(19) United States
(12) Patent Application Publication
(10) Pub. No.: US 2009/0210412 A1
(43) Pub. Date: Aug. 20, 2009

(54) Method for searching and indexing data and a system for implementing same

(76) Inventors: Brian Oliver, Ledyard, CT (US); Shawn Terry, Preston, CT (US)

Correspondence Address: TOBIN, CARBERRY, O'MALLEY, RILEY, SELINGER, P.C., 43 BROAD STREET, PO BOX 58, NEW LONDON, CT, 06320, US

(21) Appl. No.: 12/322,462

(22) Filed: Feb. 2, 2009

Related U.S. Application Data
(60) Provisional application No. 61/063,230, filed on Feb. 1, 2008.

(51) Int. Cl. G06F 17/30

(52) U.S. Cl. 707/5; 707/E17.01; 707/E17.032; 707/E17.015; 706/52

(57) ABSTRACT

A system and method for processing a plurality of data to identify and search words contained with the plurality of data, wherein prior knowledge of the data format is unknown, is provided. The method includes identifying words within the data, wherein indentifying includes, processing the data to identify words, prior to searching. The method also includes storing the words in a predetermined manner and searching the words, wherein searching includes searching the words responsive to at least one search term to identify match results and processing the match results to at least one of save the match results to a file and display the match results.

### RELATED APPLICATIONS

This application claims benefit of U.S. Provisional Patent Application Ser. No. 61/063,230 (Atty. Docket No. 5303.112957) filed Feb. 1, 2008, the contents of which are incorporated by reference herein in its entirety.

### FIELD OF THE INVENTION

This invention relates generally to processing large amounts of data on a wide variety of file systems and more particularly to a method and system for indexing and searching volumes of data from a wide variety of file systems.

### BACKGROUND OF THE INVENTION

As an increasing number of businesses rely on computer systems for conducting business operations and/or storing large amounts of data, media restoration and data conversion services becomes a critical element in the continuity of the business enterprise in the event of a catastrophic occurrence or the need to process extremely large amounts of data. Older utilities exist that read the contents of each data file and search the content for a search term. Latter variations on this theme allowed searching for variants of a search term using something known as regular expressions. These utilities were somewhat effective in being able to find a small number of search terms in a small group of files, but lacked the performance required to search a large volume of data or to search a large number of search terms in a reasonable amount of time. Algorithmic improvements over time along with faster Processor speeds have improved this situation, but they still require an O(log(n)) when searching for exact matches and O(n) when searching for inexact or fuzzy matches. Where n is the number of search terms. In many situations where text is being searched, inexact or fuzzy matches are desired. And in most text typed by humans in standard office documents (unlike published books that are heavily checked and edited) spelling and typographical errors are common resulting in the desire or need to do an inexact or fuzzy match against the search term. The big issue though can become that you do not want the match to be too inexact to the extent that you accept other common words as a match to the relatively uncommon search term. As a result good matching algorithms are relatively processor intensive and are O(n) resulting in inefficient and very slow performance on a general purpose CPU when there is a large number of search terms.

Another common method used to search for a large number of search terms is to process each data file in a volume by collecting all of the words and storing them into an indexed database. The database can then be searched for the search terms. Unfortunately, the problem with this method is that there is a need to avoid over populating the database. This is because as database disk space requirements increase, performance typically decreases as the number of words increase. This leads to a need to only populate the database with words that you know come from file format defined text fields within the files. This means that you need to know the file format of all of the files that are being processed and if file type is not understood, that file and the words within it would not be stored. Additionally, as the method uses a traditional database technology to store words processing is typically slow.

### SUMMARY OF THE INVENTION

A method for processing a plurality of data to identify and search words contained with the plurality of data, wherein knowledge of the data format is unknown, is provided. The method includes identifying words within the data, wherein indentifying includes, processing the data to identify words, prior to searching. The method also includes storing the words in a predetermined manner and searching the words, wherein searching includes searching the words responsive to at least one search term to identify match results and processing the match results to at least one of save the match results to a file and display the match results.

A method for indentifying words contained within a plurality of data, wherein knowledge of the data format is unknown, is provided and includes determining a natural constructed language of at least a portion of the data; processing the data responsive to the natural language to identify words contained within the data, prior to searching; and storing the words using at least one of a linear storage method and an indexed storage method.

A method for searching identified words contained within a plurality of data, wherein knowledge of the data format is unknown, is provided and includes receiving at least one search term and searching the words responsive to the at least one search term to identify match results. The searching is conducted via multiple search engines configured to conduct an exact or fuzzy search of the words in parallel, and processing the match results to at least one of save the match results to a file and display the match results.

A system for implementing a method for searching and indexing a plurality of data contained within a data file is provided where the system includes a device for receiving data, a device for storing the data and a device for implementing a method for processing the data to identify and search words contained with the data, wherein knowledge of the data format is unknown. The method includes identifying words within the data, wherein the identifying includes, processing the data to identify words, prior to searching, and storing the words in a predetermined manner. The method also includes searching the words responsive to at least one search term to identify match results, and processing the match results to at least one of save the match results to a file and display the match results.

A computer readable storage medium having computer executable instructions for implementing a method for processing a plurality of data to identify and search words contained with the data, wherein knowledge of the data format is unknown. The method includes identifying words within the data, wherein the identifying includes, processing the data to identify words, prior to searching and storing the words in a predetermined manner. The method also includes searching the responsive to at least one search term to identify match results, and processing the match results to at least one of save the match results to a file and display the match results.

A system for identifying and searching words contained with a plurality of data, wherein knowledge of the data format is unknown, is provided where the system includes an input device, a memory device, an index processing device, a processing device in signal communication with the input device and the memory device and an index processor coupled to the memory device, wherein the processing device is configured to receive data, distribute the data to a processor, identify a word in the data using the processor, generate a word reference by recording a location of the word, calculate a hash value(s) for the word reference, store the word reference in a structured manner using the hash value, transfer the reference and the hash value to at least one table in the memory, search the words responsive to at least one search term to identify match results, and process the match results to at least one of save the match results to a file and display the match results.

A search and indexing system is provided and includes a data reader configured to read data, a data processor coupled to the data reader, wherein the data processor is configured to determine content of the data, an index processor coupled to the data processor and configured to index the data, wherein the index processor includes a search/detect processor configured to detect a word in the data and to create a hash value(s) from the word and a memory coupled to the index processor, wherein a word reference is generated responsive to said word and stored in the memory, the memory being configured to transfer the word reference and the hash value to a table.

### BRIEF DESCRIPTION OF DRAWINGS

The foregoing and other features and advantages of the present invention will be better understood from the following detailed description of illustrative embodiments, taken in conjunction with the accompanying drawings in which:

FIG. 1 is an operational block diagram illustrating an overall method for processing data in accordance with an embodiment of the invention.

FIG. 2 is an operational block diagram illustrating a method for determining information about a file and/or data stream in accordance with the overall method of FIG. 1.

FIG. 2A is an operational block diagram illustrating one embodiment of an index storage method, in accordance with the overall method of FIG. 1.

FIG. 3 is a schematic block diagram illustrating one embodiment of the indexed search method in accordance with the overall method of FIG. 1.

FIG. 4 is a schematic block diagram illustrating the indexed search method of FIG. 3.

FIG. 5 is a schematic block diagram illustrating the indexed search method of FIG. 3.

FIG. 6 is a schematic block diagram illustrating the indexed search method of FIG. 3.

FIG. 7 is a schematic flow block diagram illustrating one embodiment of a system for searching and indexing data in accordance with the invention.

FIG. 8 is a schematic flow block diagram illustrating one embodiment of an index processing device in accordance with the invention.

FIG. 9 is a schematic flow block diagram illustrating one embodiment of a processing device configured as a linear detect processor, in accordance with the invention

FIG. 10 is a block diagram illustrating an example of one embodiment of the linear detect method of the present invention.

### DETAILED DESCRIPTION OF THE INVENTION

In accordance with the present invention, the system and method disclosed herein differs from existing methods and systems in that the file format is not required, a traditional database is not used to store the word references that are located, and if a linear search for a search term is performed, it is done using a massively parallel hardware implemented processor capable of O(l) scalability up to a reasonable number of search terms.

In accordance with the present invention, a method and system for processing a plurality of data (stored in one or more data files) is disclosed where the method and system searches and indexes arbitrary files and streams of data. The method, which balances performance, accuracy and level of implementation effort, identifies words (including, but not limited to, proper names, industry specific terms, common abbreviations and specially defined terms) that occur in a file or a volume of files. One approach of performing this task may include assuming that text could occur anywhere in the file and may be represented by a variety of common character encodings. The file and/or parts of the file may be ‘tagged’ or identified for special handling as may be desired. Additionally, the file may be treated as a stream of bytes which may contain characters that may be defined as desired or as dictated by the code page, where the code page may be known beforehand or may be determined by performing an analysis of the file. Some examples of character definitions may include a single byte (such as ASCII/EBCDIC numeric value), variable length byte (such as Unicode Transformation Format or UTF-8 value) and/or double length byte (such as UTF-16 value). It should be appreciated that although the invention is disclosed herein as related to single language processing, multi-language processing may be accomplished by changing language specific parameters to support files having data in different languages. This is useful because some files (data) in a volume of files may include different languages.

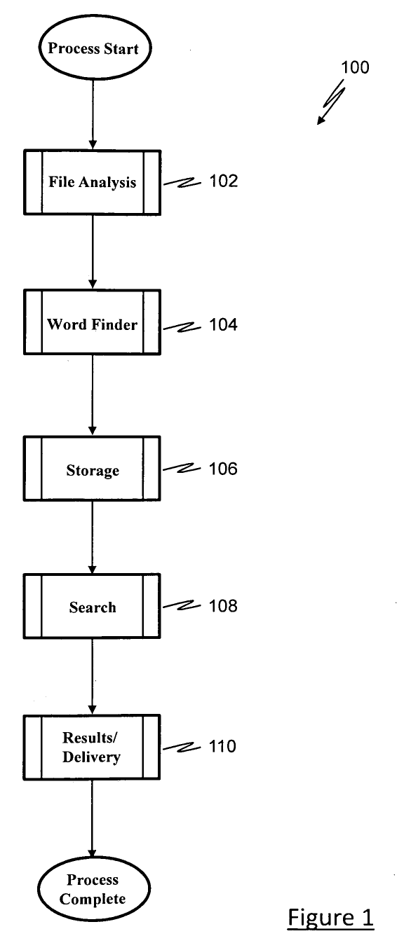

Referring to FIG. 1, an operational block diagram illustrating an overall method 100 for processing data in accordance with the invention is provided. The method 100 includes performing an analysis of the data file(s), as shown in operational block 102, to determine parameters/information regarding the file(s) and/or data and processing the data to identify characters and/or words, as shown in operational block 104, where the identified words are associated with a word reference. The method 100 further includes storing the data (i.e. word references) in a predetermined and structured manner, as shown in operational block 106, and searching the stored data for desired search terms, as shown in operational block 108, where the search terms may include desired words and/or phrases. The results may then be communicated as desired, as shown in operational block 110. It should be appreciated that each of the operations disclosed hereinabove with reference to operational blocks 102-110 are discussed in greater detail hereinafter.

In accordance with the present invention, before processing the data to identify characters and/or words (as shown in operational block 104) it would be beneficial to know certain parameters about the data/file in advance to aid in accurately analyzing the data/file. These parameters may include the language(s) used and the code pages, as well as if any special handling is required. More information will allow for a more efficient and accurate search. It should be appreciated that the information may be determined by examining a portion of the data in the file(s) (for example, the first few hundred bytes of the file) to accurately identify the type of file. An appropriate handler for that file type may be identified and used to determine other parameters for identifying characters and/or words. It should be appreciated that if file type cannot be identified, other strategies may be used (such as, looking at portions of the files data to determine desired parameters). If the initial parameterization (i.e. a first set of processing parameters) does not provide satisfactory results (for example, accuracy), a more complex file analysis may be performed to obtain the desired parameters (i.e. a first set of processing parameters). This may include an analysis of the data to look for sections of text and the language of that text and/or an analysis of the entropy of the file data to determine if all or part of the data is compressed data or image data.

Referring again to FIG. 1, processing of the data to identify characters and/or words, as shown in operational block 104, may be accomplished using a word detection algorithm that processes the file as a stream of bytes. To identify a word, the algorithm ‘looks for’ characters that are within the valid ASCII and/or Unicode range for the defined code page(s) and when a character is found, the algorithm determines if the character is valid. If the character is valid, the algorithm creates characters from bytes using a UTF-8 and/or UTF-16 decoder and the character is added to a buffer for later storage. As above, the algorithm analyzes the remaining identified characters, determines if they are valid and adds the valid characters to the buffer. When the algorithm encounters a character that is not a letter or number, the algorithm treats the character as a delimiter and ends the accumulation of the word. It should be appreciated that it is possible that the buffer may contain a valid word, but also have ‘extra’ characters (i.e. characters that do not ‘belong’ to the word) at the start and/or end of the word. In this case, these extra characters may be dealt with in the searching phase.

When a valid word is found the algorithm examines the found word to determine if the found word should be accepted as a word by the algorithm. To accomplish this, the algorithm may generate a candidate word by converting the found word into all capital letters and removing any punctuation. The candidate word may then be vetted or examined to determine if the candidate word should be accepted. This may be accomplished by determining whether a group of words (word group) has already been created by the algorithm for the file being examined. If a group of words has been created, then the candidate word is automatically accepted as part of the group. However, if the candidate word is not part of a group, then two (2) tests are performed on the candidate word to determine if it should be accepted as a word, where passage of either test results in the candidate word being accepted as a word by the algorithm. The first test involves determining whether the candidate word includes three characters (or more) and at least one vowel (or a foreign language equivalent). The second test involves hashing the candidate word into a 24-bit hash value (other size hash values may be used) and using the hash value to address a dictionary table. If the hash value is a hit on a valid language dependent word, the addressed bit in the dictionary table may be set accordingly and the candidate word is accepted.

It should be appreciated that the hash addressed dictionary table may be created or may be a commercially available dictionary and may include proper names, common abbreviations and industry specific terms, such as legal and medical terminology and abbreviations. It should also be appreciated that the use of a dictionary table allows for positive hit determination of all words from the supplied dictionaries. Moreover, due to the limited bit length of the hash value, it is recognized that two different candidate words could hash to the same value. This could cause a character combination which is not a word to be interpreted as a valid word. It is contemplated that the present invention tolerates this and anticipates that a percentage of the indexed words are not valid words.

It should be appreciated that the location of a word in a file is typically just its byte offset within the file. And although this is generally fine and does not cause problems because the locality searching functionality is tolerant of gaps between words, there are certain file types that have characteristics known to cause the search facility to not function accurately. One such characteristic involves more than one large gap between the words of a phrase, while another characteristic involves words that are not in the proper order. In order to address these issues, if one of these situations is known to occur with the file type of the file being processed, then a special file type handler may be used and will be able to address these issues. For example, the special file type handler may be configured to act accordingly by knowing enough about the format to either restructure the data and/or provide the algorithm proper parameters on how to process the file, where the parameters could point to fields of text and data within the fields can be treated as words. Alternatively, the data may be reordered before processing the data to identify characters and/or words. Still yet, if the text is out of sequence, or words and/or phrases are broken into segments, the handler may reorder the text back into its proper order. It is contemplated that in the case where it is determined that a satisfactory result may not be obtained regardless of how the data is parameterized or how the data is reordered, a format specific software implementation may be used to search for words.

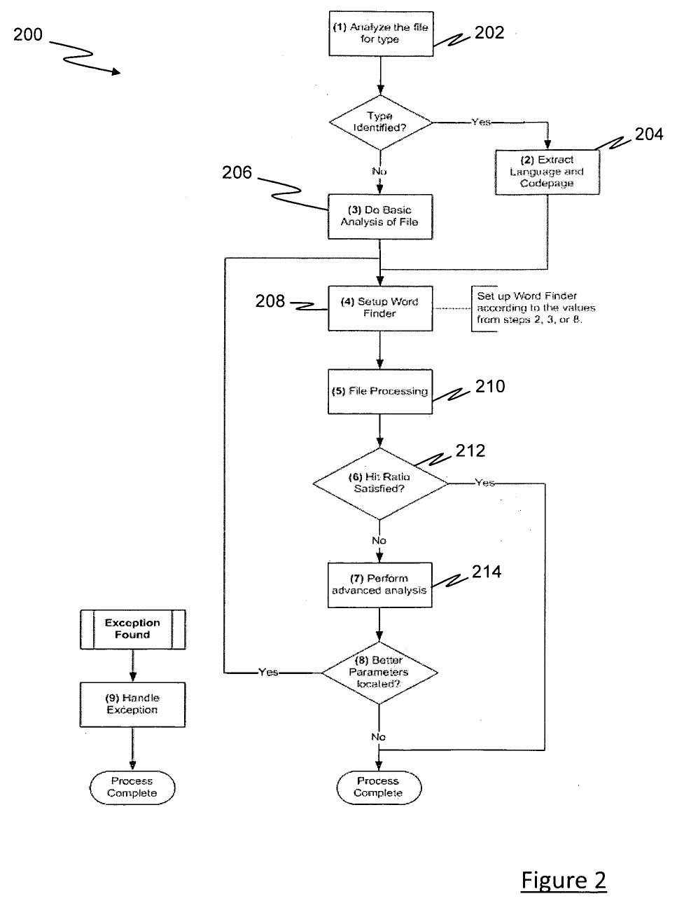

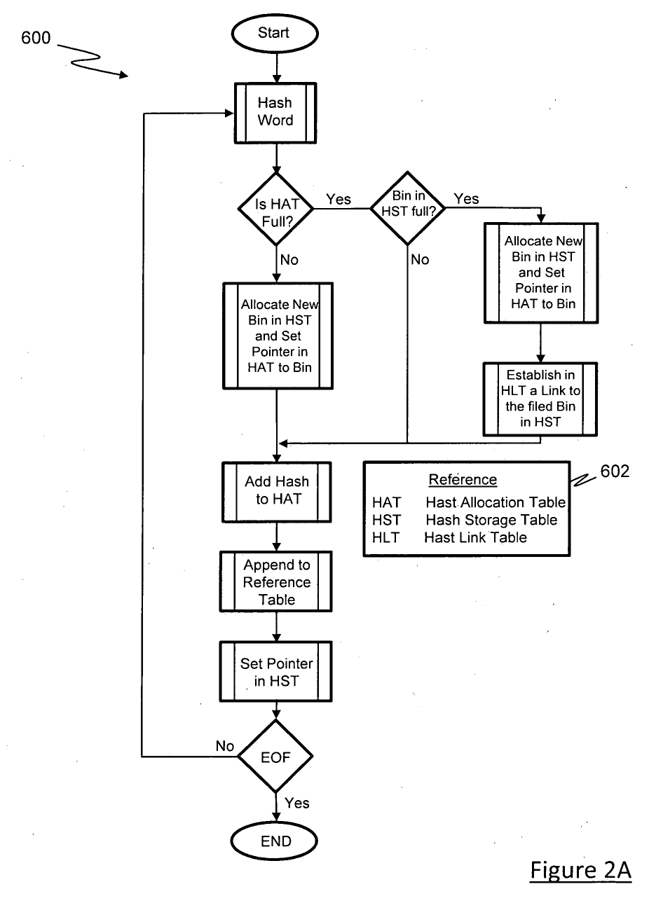

As discussed briefly hereinabove, certain information may be necessary to identify words and/or characters in a file and/or data stream. This information, along with the file data, may include the character encoding scheme, the code page and the language. In accordance with one embodiment of the invention, a method 200 for determining this information is illustrated in FIG. 2 and includes identifying or analyzing the file to determine the file type, as shown in operational block 202. This may include conducting a basic analysis of the file to efficiently identify the file type or this may include finding enough information from the file to determine proper parameters that can be used for a vast majority of situations. This analysis may be conducted by examining the file to determine the file extension and the file structure, which can be accomplished by looking at both the file extension and specific combinations of bytes at specific locations within the file. For example, in many cases the file header can be used to identify its type although this is not always the case. Signature analysis software is widely available and may be used to provide this functionality.

If the file type can be determined, then the language and code page are extracted, as shown in operational block 204. If the language can be determined but not the code page, then a common code page for that language can be utilized. On the other hand, if the language cannot be determined, then the default will be set to the language represented by a majority of the recently processed files of this type. The code page will then be set to an appropriate default to match the language. If the file type cannot be determined, then as shown in operational block 206, an analysis of the file is conducted and may include taking samples of the file and comparing the samples with the installed dictionary. The analysis may also include processing the file following a basic analysis that will attempt to determine the character encoding scheme, code pages and language. This processing may use defaults based on other files that appear to have a similar type. The likelihood of image or compressed data can be determined by sampling data from various parts of the file and looking at the entropy of this data. Compressed and uncompressed data tend to have a characteristic pattern upon analysis. For example, compressed data (including compressed image data) has a very high level of entropy. It should be appreciated that the classification of data type may be used to set a hit ratio threshold, where the ‘hit’ ratio may be assigned and may be set high, unless image or compressed data is found, in which case the ‘hit’ ratio may be set low.

At this point, the system is configured to process the file to identify words, as shown in operational block 208. This may include setting up the word finder with valid character ranges within the code page, valid delimiters in the code page and the language, language dependent vowels, skip threshold, byte offset ranges of text (including character encoding) and the dictionary. Depending on the results of the file type identification/analysis, appropriate character decoders may be enabled or disabled. The file is then processed to identify words, as shown in operational block 210. This processing may begin by running the data through character decoders, the output of which is processed to identify words, where a count of the number of word dictionary hits and the number of bytes processed is recorded and used to calculate a hit ratio. Once all the file data has been processed, the hit ratio is evaluated, as shown in operational block 212. If the hit ratio is greater than a minimum preset threshold, then the results are accepted and the next file can be processed. However if the minimum hit ratio threshold (or other criteria as may be determined and that may be defined in the future) are not met then further processing may be performed. In the situation where the minimum hit ratio threshold is not met, it is possible that the parameters were not correctly determined (this may result in few or no words being found in the file). One way to determine new parameters would be to conduct a more advanced analysis of the file, as shown in operational block 214. This may include conducting further entropy evaluation of the whole file, rather than just a sample of the file. If a text section is identified, then a more aggressive attempt may be made to find common words in a variety of different character encodings, code pages, and likely languages. If better parameters are identified then the system is reconfigured to process the file to identify words, as shown in operational block 208, and the process is repeated with the new parameters. If an exception or error happens at any point during the processing of a file or data stream, the exception handling may be invoked, where details on the exception may be saved along with the file and/or data stream contents.

As discussed briefly hereinabove, a statistic counter of words that hit the dictionary may be implemented which should help with language and code page verification. The value of this counter may be converted to a word-hit ratio as desired, such as by dividing the value by the byte count of the file. This ratio may then get compared to a minimum expected threshold to determine if it is likely that the correct code page and language are used. If very few or no dictionary words are found then it may be due to the usage of an incorrect language or code page. If the hit count is below the minimum expected threshold, then further analysis may be pursued. It should be appreciated that it is possible that a single file may employ multiple character encoding schemes, code pages, and languages. When it can be determined in advance that this is the case, the file or data stream may be divided into sections where each section may be processed using new parameters for that section to determine character encoding, code page, and language. The file may also be split into segments of a predetermined size (for example, 2 gigabytes per section if the total file size is larger than 2 gigabytes).

As discussed hereinabove, the method 100 includes storing the data (i.e. word references) in a predetermined and structured manner, which may be accomplished via a variety of methods. One such method is referred to as ‘the linear storage method’ and simply appends the word reference to a single table, where the table gets transferred to the next phase when the table is full. In accordance with the invention, references may be accumulated at a rapid rate and these references must be committed to memory and eventually to disk. In some cases there may be millions of word references generated for each gigabyte of data processed. Linear searching may use hardware acceleration along with appropriate software to attempt to find the search terms and create a score as to how close a match a word reference is to a search term. As such, the number of search engines implemented limits to a reasonable number the search terms that can be efficiently supported.

Another such method is referred to as ‘the indexed storage method’ which stores the word references in a table (similar to the linear storage method) but which indexes the word references, effectively allowing the word references to be searched in an efficient manner using conventional software techniques. One embodiment 600 of an indexed storage method is shown in FIG. 2A where acronyms used are identified in legend 602. To facilitate the indexing, a variable length word may be hashed in multiple ways to maximize the chances that the word is found in the hash table if it is misspelled or mistyped. The first portion of the hash value may be used to address a hash allocation table, while the remaining portion of the hash value, along with the word reference it points to, is stored in a hash table. This effectively creates a large number of subtables that can be quickly located and searched to find hash values and word references that are an acceptable match. Is should be appreciated that word references may include numbers as well as words. It should also be appreciated that each time a common word is encountered it will hash to the same value which will result in certain subtables being filled more rapidly than other subtables that no common word hashes to. Accordingly, the present invention accommodates this in an efficient manner without requiring a dynamic memory allocation functionality. It should be appreciated that when the main memory tables are filled, the contents of these tables are written to disk in a predetermined and structured manner and the tables are then reinitialized.

As discussed briefly hereinabove, references can accumulate at a rapid rate and must be stored in an efficient manner for searching. One method for accomplishing this is to store the references in an indexed manner. The Indexed Storage Method uses hardware based (and/or software based) processing to index the words that are found so that these indexes can easily be searched for the word. For example, if a terabyte of data is processed it can be assumed that approximately 3 billion word references may be found in this terabyte of data which would generate approximately 90 GB of output (3 GB×30). Although the output data is all indexed a typical search session of a few hundred words may generate millions of index lookups. This is because of fuzzy matches, which may be typically desired where many permutations of a word are looked up in an attempt to find words with a spelling or typographical mistake.

Word references should be able to be looked up by content. One structure of a word reference may include the word being represented as 6 bits per character, which means that for a 2-15 letter word, there can be anywhere from 12-90 bits. Accordingly, it may be desirable to convert this word reference to a fixed bit width hash value that can then be used as an index to make searching more efficient. If a word reference is found within the dictionary, one hash value may created for the entire word. If the word reference is not found within the dictionary, then it is possible that the word is incorrectly spelled or typed. One way to address this is to generate multiple indexes by hashing (i.e. generating hash values) from different portions of the word. It should be appreciated that in order to have an effective hash value, at least four characters within a word reference must be used to form a hash value. Although the present invention contemplates that four hash values may be generated for a word of five characters or more long, more could be generated if desired.

In one embodiment, a first hash value may use the first four letters of the word, a second hash value the last four letters, a third hash value may use every other character starting at the first character (1,3,5 . . . ) (with the last three characters being used for a five-letter word and the last two for a six-letter word) and a fourth hash value may use every other character starting at the second character (2, 4, 6 . . . ), where in the case of a five-letter word the first three characters may be included. The first two characters are included in the hash value for a six and seven letter word. In this way we would be at some point skipping every letter in the word in one of the hashes avoiding any single letter spelling or typographical error. And by using the beginning and end of the word in two of the hash value generation most situations of missing and extra letters may be avoided. The real decision of how close the match is can be made during the search but the reference may never be found if one or more of the indexes do not match.

It should be appreciated that the hash values may be calculated using a standard hashing algorithm to generate hash values (such as 32 bit hash values). These hash values, along with a number representing the file or portion of the file and offset within the file, may be stored within an indexed hash table. An additional table may be organized as an unsorted sub-table, where the sub-table selection may be determined from a portion of the hash value. For example, for a 32-bit hash valve, the hash table may be organized into 1 million unsorted (1,048,576) subtables and the table selection may come from the upper 20 bits of the 32 bit hash value known as the hash prefix. In this way, when searching for a hash value in the entire table the subtable may be selected based on the hash prefix. Lastly, the subtable is searched linearly for the remainder of the hash value.

Although there are many strategies to sort references, one of the most limiting factors in storing references in a organized manner is memory access times. Although computer memory can be sequentially accessed very quickly, access to random memory locations take much longer (in some cases, up to 20 times longer). The population of the main hash table may be done in two stages, where the first stage may be implemented in hardware (and/or software) logic and may maintain the Reference Storage Table and the associated hash allocation and hash link tables in fast access static RAM which can be randomly accessed very quickly. The second stage occurs when this table fills. At this point its contents are moved in an ordered fashion into similarly structured but larger storage tables that may reside in the computer's main memory. The transfer into this table is done mostly sequentially avoiding the random access performance penalty that occurs when accessing host main memory.

It should be appreciated that the hardware hash algorithm may maintain four tables; a hash storage table, a hash allocation table, a hash link table, and the reference table. The hash storage table is the largest table and holds the hash elements as described above. For example, a hardware based version may include 524,288 bins, where each bin can hold 16 hash elements and where each hash element within this hash table is 32 bits and holds the remaining 12 bits of the hash value and a 20-bit pointer into the word reference table.

The hash allocation table is an array of pointers to the latest allocation for that bin in the hash storage table and the table has a location for each of the Hash Storage subtables. To continue the example above, the upper 20 bits of the 32-bit hash value are used to address this look up table and points to the bin in the hash storage table that is currently being filled with entries for that subtable. Each element of this table is 32 bits wide. The hash link table is a table that contains elements for each bin the hash storage table and that maintains pointers so that all the bins that go to a particular table can be traversed. To continue the example above, the hash link table may contain 524,288 elements (one for each bin in the hash storage table) and maintains pointers so that all the bins that go to a particular subtable can be traversed. The entries are added to this table each time a bin is allocated to point to the bin that has just filled up for that subtable thereby creating a linked list of pointers to all bins for that hash prefix. The chain of pointers in this table may be used to collect all the bins that go with each subtable. Again, in this example each element of this table is 32 bits wide.

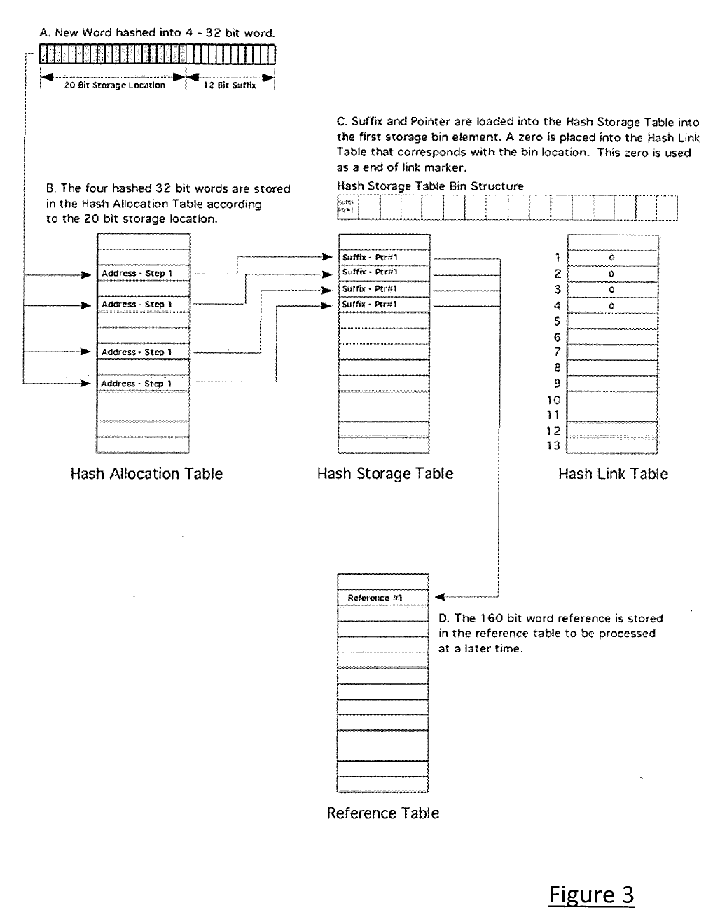

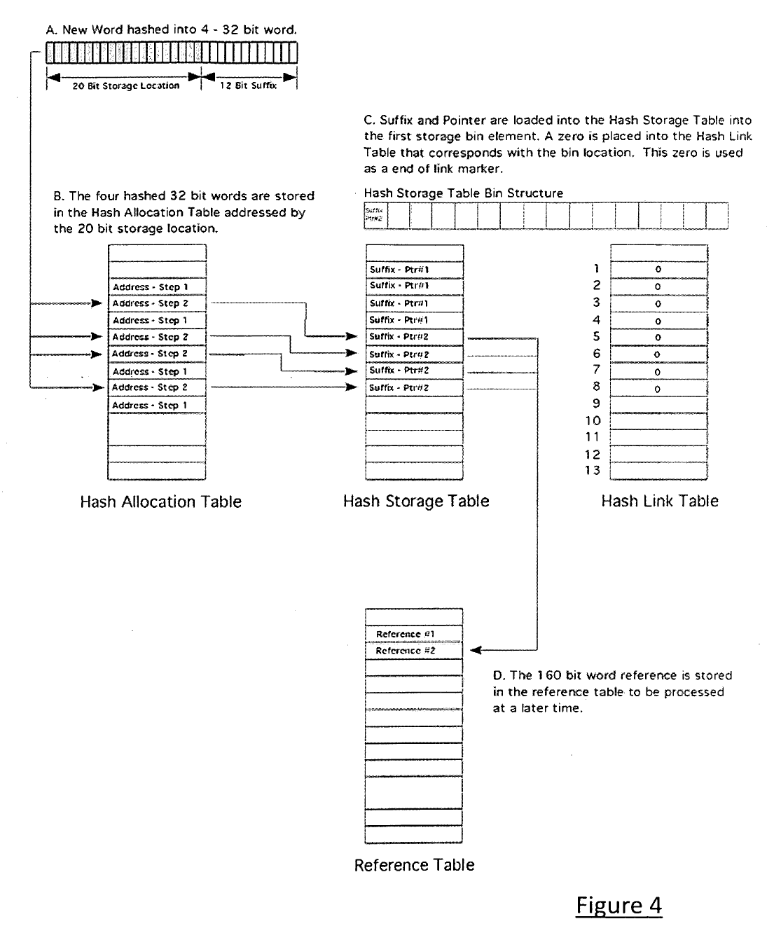

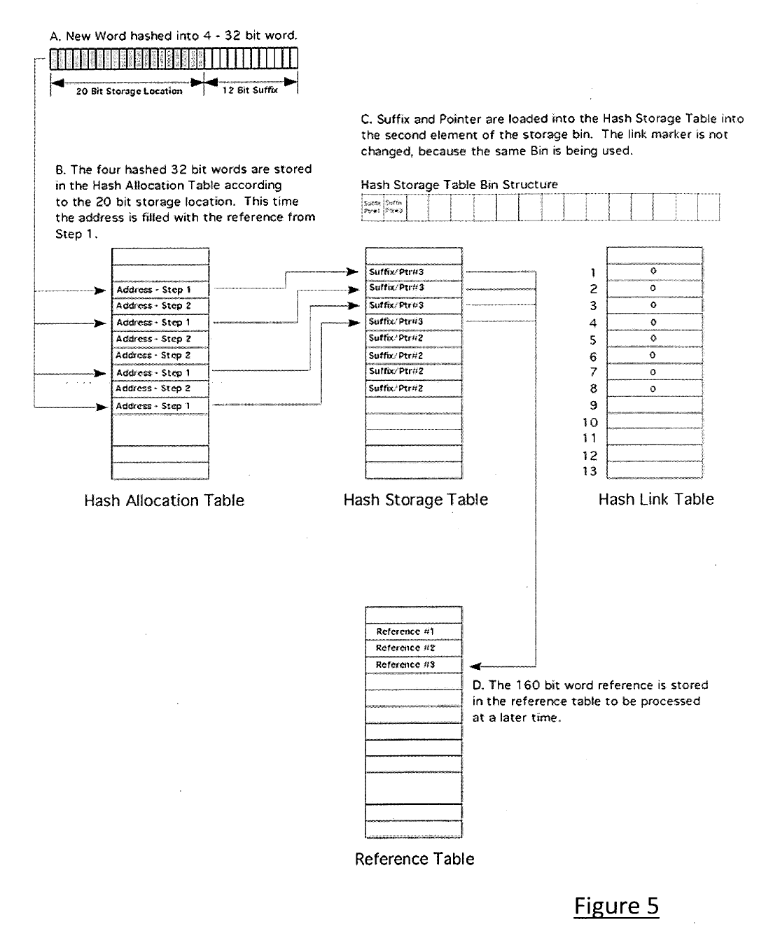

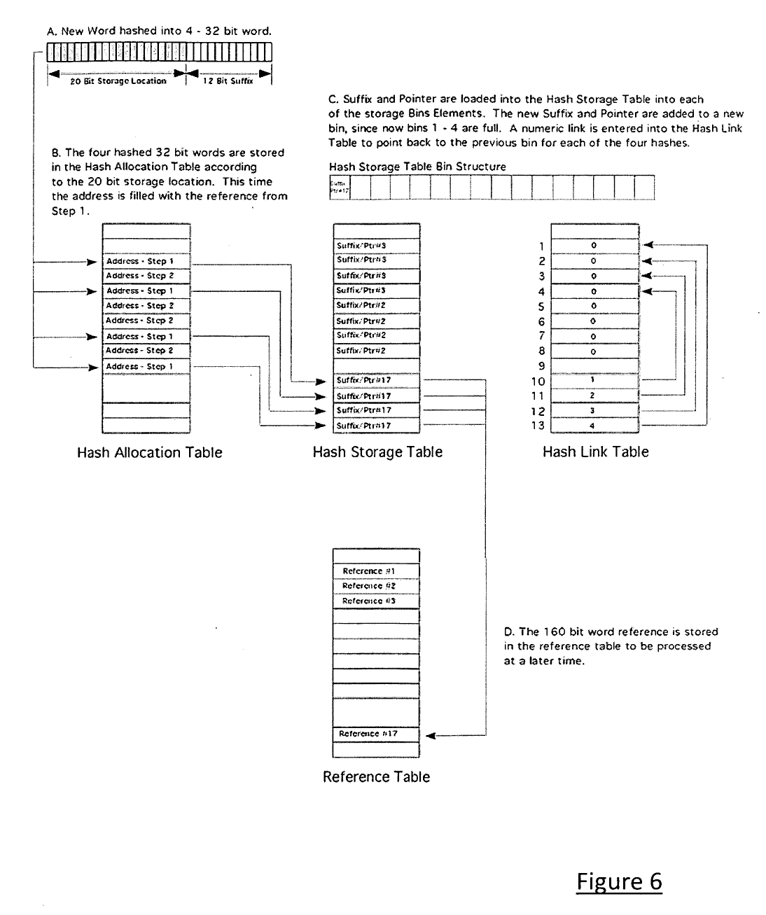

Referring to FIGS. 3-6, the indexing method may be implemented as follows. When a new word reference is found it is first added to the next free spot in the reference table. The word also may be hashed to create a 32-bit hash value. The next step is to take the 20-bit hash prefix to address the hash allocation table. If this points to an element in the hash storage table and the bin is not full, then the reference is added to the hash storage table. If the bin is full, then a new bin is allocated, a link is created to the full bin in the hash link table and the hash allocation table is updated with the address of the newly allocated bin. This illustration shows the new link table management to establish the linking to the first bins. Regarding the reference table, for every new entry into the reference table, there may be one or four entries in the hash storage table. This is because a word reference is either simply hashed (if a dictionary hit occurs) or hashed four different ways as discussed above. As such, the hash allocation table is typically sparsely populated based on the number of different hash prefixes and the hash link table simply reflects the chain of bins in the hash storage table for a particular allocation. As a result, for each new entry found 24 or 36 bytes of storage are consumed in total for all tables to store the associated information. If the new entry into the reference table is a number, the value of the number may be hashed using the same hashing algorithm discussed above and stored and indexed in the same manner as a word reference. When all of the bins in the hash storage table or the reference table are full, processing is suspended and the hardware-based tables are transferred to the main tables in the memory of the host computer. Although in this case, either table being filled will trigger this transfer action The first step may be to transfer the reference table as a contiguous block and append it to the main reference table. Next, all of the hash entries for a particular hash prefix sub-table may be transferred, which may be accomplished by sending all of the populated elements in the hash storage table bin pointed to by the particular entry in the hash allocation table. This may be advantageous if there is a link for that entry in the hash link table this is followed and all the elements in that bin are transferred. This process may continue until all the bins associated with that hash prefix are sent. As the links may be followed in the opposite order of how they were created, the bins may be transferred and stored in reverse order, although the order of storage does not matter for the search processing. In this manner the host computer may receive all of the hash entries as a contiguous block of data that can simply and efficiently be stored. Once everything has been transferred the hardware-based tables may be reinitialized and processing can again proceed.

Accordingly, the tables in memory of the host computer may be organized in the same way as the hardware based tables except that the number of bins in the hash storage table may be much larger based on available main memory. Likewise the size of the reference table may be much larger as well. For example, a typical number of bins in the hash storage table may be 64 million bins which would be able to hold up to 1 billion hash elements and the reference table may be able to hold up to 256 million entries. And since the reference table is larger, each element of the hash storage table may be 48 bits to accommodate the need for a wider pointer with 12 bits for the hash suffix and up to 36 bits for the pointer into the reference table. A fifth table may be created on the host computer that contains a list of pointers to all the references that are numeric references (as opposed to word references). This allows all the numbers in a file or all the files to be quickly found and searched (for example, linearly). When the main memory table fills it may be transferred to disk storage essentially as an image of what is contained in memory. During an indexing session many such images may be created and when searching is performed each image may be read into memory from disk, where all of the words and their variants may be searched for as described herein. When the processing of the image is completed, the next image may be read into memory until all images have been processed.

Alternatively to the previous methods, another method that combines these two designs is the direct storage of the word references found, followed by hardware (and/or software) accelerated linear searching of the word references. The storage step in this method may simply be the output of the word finder algorithm and may simply be stored as a 128-bit output with a 32-bit appendage that is ordinal to the file name and/or data stream. This means that each word reference may be 160 bits, or five 32-bit words. This output is simply accumulated into memory and transferred at the earliest opportunity to the main memory of the host computer. It should be appreciated that processing does not have to stop during this transfer. After all of the word references have been found and committed to volumes on disk, every word of the processed volume is sorted essentially chronological. This method naturally results in the word reference(s) being sorted by the order in which the files were presented and then by its location in each file. Searching may begin by implementing dozens of search engines (i.e. via a gate array), where each search engine may be capable of searching for several words that it has been programmed to search for. The programming can also include some rules to define how close a word reference must be to the word you are attempting to find to be accepted. A number can also easily be searched for as the search engine may distinguish numeric references from word references and can handle numeric references using separate numeric search logic elements.

Once the data is stored in a predetermined and structured manner, the segments that were stored are read back into memory and processed responsive to at least one search request. Although search requests can be conducted on single request basis, it is recommended that the search requests be batched as each segment may contain gigabytes of information and may take several minutes to search. Accordingly, the entire batch of search terms can be processed against each segment before the next segment is loaded. Typically, a search request is initiated by entering search terms (e.g. words and/or phrases) into a search interface (such as a Graphical User Interface) which interacts with the system to implement the method 100. However, it is contemplated that the search request may be initiated via an automated process. The entered search terms may include parameters or attributes that define 1) how close the match must be in terms of misspelling and/or mistyping, and/or 2) how close the phrase must matched in terms of word order, and/or 3) how many and which of the words must appear. Once a batch of search terms (and their attributes) have been entered, the terms may be searched. This may be accomplished by processing the search terms to convert all of the characters in the search terms (i.e. words) to upper case and removing punctuation. Although the invention is disclosed herein as the word searching being performed before determining whether the word references match a search phrase, any order of performance of the operation may be implemented in a manner suitable to the desired end result.

It should be appreciated that as discussed further hereinafter, the method used to search the data may be responsive to the method used to store the data. For example, data stored via a linear storage method may be searched using a linear search method. The linear search method typically employs a hardware based search technique which may implement multiple search engines in the hardware processor, each of the search engines being responsible for one of the search terms. The search engines then conduct a comparison of the identified word references in parallel, where if a word reference satisfies desired parameters, a matched is determined to have occurred and the word reference is accepted. On the other hand, data stored via an indexed storage method may be searched using an indexed search method, where the indexed search method may involve hashing the search term to create a search hash value. It is contemplated that other hash values may be created for the search term to account for misspellings and other errors. The search hash values may then be looked up in the index table and any applicable word references may be examined to determine if they satisfy the parameters of a match (i.e. are they close enough to the search term?). It should be appreciated that in the case of a single word search term, all references to the search term and its derivatives are returned with the highest-ranking being assigned to matches of the exact term. Moreover, many common words are searched simply to facilitate phrase matching and these words may not be returned as a separate entity.

When the search term includes a phrase, the phrase may be processed by first matching the first word of the phrase and then the following words in the phrase that are related to the file. Once the matches to the words in the phrase have been identified, an evaluation algorithm may be implemented responsive to the attributes that accompany the phrase search term, wherein the evaluation algorithm examines the matches to determine if all or most of the words are available in close proximity to each other and generally in the correct order. The results may then be ranked based on the determination. For example, a high rank may be given if all of the words are present in close proximity and in the correct order with the rank level decreasing if one or more words is missing or if the order of two or more words are swapped. It should be appreciated that portions of the searching function may be implemented using various utilities depending upon the situation. For example, certain file types may store text data in unusual ways which could affect the efficiency and accuracy of method 100. If one of these file types is encountered and words are found that suggest the possibility of a phrase than the original file could be processed by a separate low performance converter or parser to locate the phrase and make a better evaluation of the locality of the words. The result of this evaluation may then be used to rank this phrase as described above.

Once the data has been processed and the results obtained, the results may be communicated to an interested party or parties and may include 1) what was searched for; 2) what words/phrases were found; 3) the location of the found words/phrases; 4) an output showing the context where the search term appears for document file types; and 5) a copy of the file that contains the search term(s). This may be accomplished via a variety of methods, such as by displaying the results on a website accessible by the interested party where the results are shown and ranked based on how close the search terms and found words match (in a manner similar to search results obtained via internet search engines). Alternatively, the results may be communicated via a standard database along with statistics on match quality and performance. Accordingly, database operations may be performed on the results to establish criteria as to what data may be accepted and what data may be denied. For example, developed criteria may be to accept only documents that fall within a desired date range and that include more than one search term. It should be appreciated that when a search results in a ‘hit’ on a file, that file may be referenced to gather the entire context surrounding the found word and/or phrase. This may be valuable as the text of the file or document may not be reconstructable from the word references.

It should be appreciated that high performance may be achieved by having all or a portion of the algorithm described herein implemented using logic inside of a dedicated hardware device (for example, a gate array, an ASIC, etc). This device may be electrically connected to two banks of static RAM that can be simultaneously addressed in a random (non sequential) manner very quickly (e.g. less than 8 ns per access). The logic implemented algorithms may include a character processor for parsing UTF-8 and UTF-16 sequences, a word analyzer having some special handling capabilities, a dictionary lookup capability where the dictionary itself may be stored in fast access RAM, a hash value generator for generating hash values from the word, capability for maintaining the first level hardware based index table for multiple random accesses per entry and/or the search engine(s). Moreover, it is contemplated that all or a portion of the invention may be implemented in a modern high performance programming language, such as C/C++.

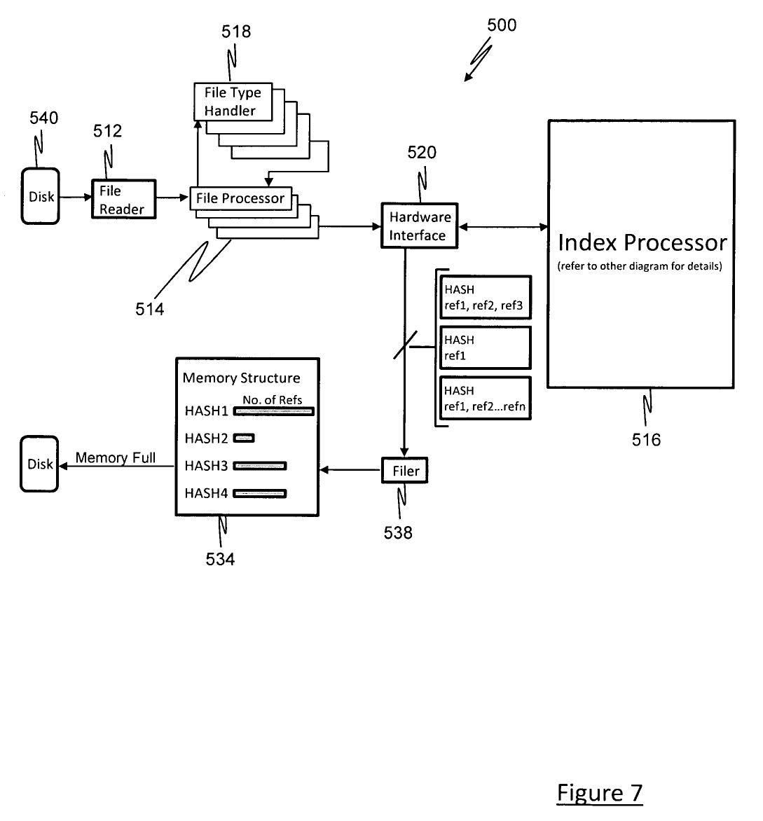

Referring to FIG. 7, one embodiment of a system 500 for searching and indexing data is illustrated and includes a file reader 512 that can read multiple files from 540 in a controlled fashion to maintain performance. The file reader 512 may be capable of reading an entire file (or a large portion of a file) into a memory buffer, where when the memory buffer is full, the file reader 512 may process the next file if one exists (or read the next portion of the large file). In this way, the file reader 512 may perform sequential file reads to optimize disk read performance while providing the rest of the system concurrent file streams of data that may be processed in parallel. The file reader 512 is capable of reading files from a wide variety of file systems through various means, such as system specific file system handlers.

The output of the file reader feeds single or multiple instances of the File Processor 514 that does the file analysis and invokes the proper File Type Handler 518 as appropriate, if this is necessary to properly process that type of file. It is contemplated that the file type handler(s) 518 may also be configured to handle decompression of common compression formats. As such, the file type handler 518 can decompress to file streams, and then direct the resulting decompressed file streams back into the file processing device 514. And depending on the situation, such as the type of file, the file may be sent onto another file type handler 518 for format specific handling, or sent directly to an index processing device 516 for further processing. In one embodiment (as shown), the output of the file handler 518 may feed the Word Finder through a hardware interface 520 which includes an operating system specific device driver and a high performance bus interface, such as a PCI-X or PCI Express.

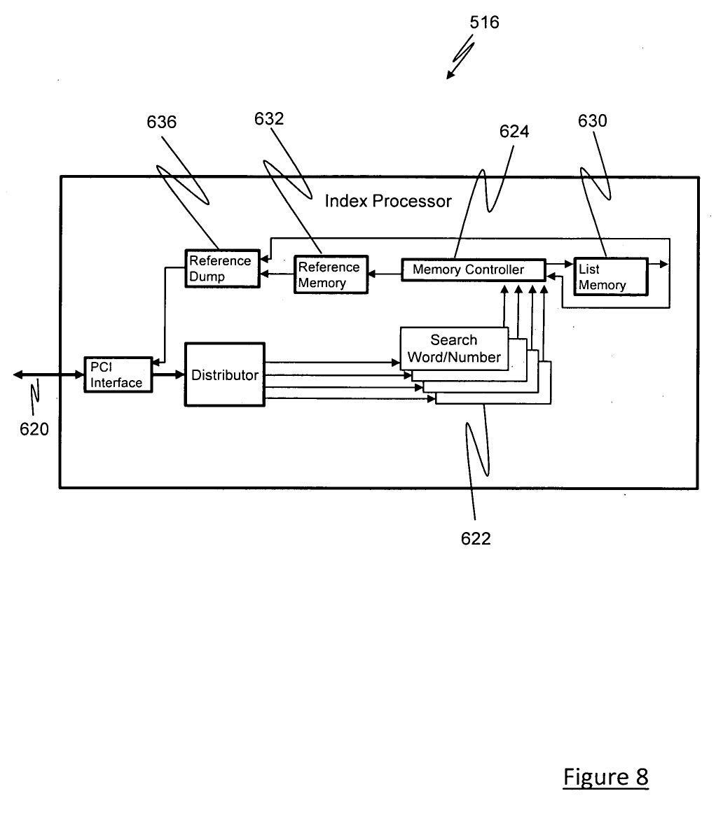

As discussed briefly herein before, the index processing device 516 may be an FPGA configured to process (either partially or wholly) data responsive to the method as discussed herein. The index processing device 516 may be implemented via a PCI-X or PCI-express board that contains a field programmable gate array (FPGA) and other desired hardware, such as dedicated memory, several interfaces, and a power supply subsystem. Referring to FIG. 8, data file streams and parameterization may be introduced into the index processing device 516 through input 620. Initially the index processing device 516 is configured to include a search processor 622 which can be implemented to process word or number detection, validate the word or number (see Word Finder Description), and direct this word reference to a table via a memory controller 624. It is contemplated that the search/detect processor 622 may include multi-core capability. In a preferred embodiment, multiple search/detect processors 622 can be utilized, yielding an architecture that can process multiple streams of information (for example, about four search/detect processors, each capable of processing 125 Megabytes per second for a total of 500 megabytes per second from four file streams).

It should be appreciated that the memory controller 624 may be connected to memory that allows truly random access to its contents very quickly, such as Static RAM (SRAM). Typical dynamic RAM (DRAM) used in computers can sequentially access a group of words very quickly, but when the processor must go to access a new group of words, the memory can take a significant amount of time to store the old group and fetch the new group. However, if the memory controller 624 utilized with index processing device 516 allows for truly random access to its contents very quickly, such as Static RAM (SRAM), words and table entries can be accessed about ten times faster than DRAM. Because almost all of the accesses by the memory controller 624 are random (with the address of the access based on the hash value) performance of the indexing by the present invention benefits greatly when utilizing truly random access memory, such as SRAM. Additionally, it is contemplated that one (or more) separately addressable banks of memory may be used, where a first memory bank may be a list memory 630 that maintains the hash table and list of the next available spot in each reference group and a second memory bank may be a reference memory 632 which maintains the word references. If the search method does not require indexing (for example the linear search method) then list memory 630 may not be used or maintained. It should be appreciated that these memory banks may or may not be simultaneously accessible. This may allow greater than fifty million word references to be stored each second.

The index processing device 516 may be configured to shift into a different mode when the memory banks are filled in which the index processing device 516 can move (or dump) the contents of the reference memory 632 to a host computer. This may be accomplished via a reference dump unit 636. When the index processing device 516 removes or dumps this data, the index processing device 516 may complete the task in sorted groups that can be efficiently stored in memory 534. It is contemplated that the removed (or dumped) groups may be handled by the filer 538, where the filer 538 can add the new references to existing groups when there is a hash value match and create a new group for new hash values if desired. The host computer can have several gigabytes of memory 534 and can be capable of holding over one billion references. When the memory 534 fills the index table it may be written to a high performance disk array 550 and a new index table may be initialized, where writing to the disk array 550 can happen as processing is continued using the new index table. The index table may be written as a contiguous large memory block, which allows for very fast writing of this data to disk. It should be appreciated that the process described above may continue until all data or a selected group of data on the source volume 540 has been processed. Once the indexing is complete, several large index tables can be located on memory disk array 550.

Searching may then be completed as desired, such as in the traditional way that an indexed search is performed. To make the searching process efficient the search terms, phrases, and/or numbers may be entered in or loaded from a file, with or without parameterization (i.e., how fuzzy, order, locality, etc). The indexing system may then process these search terms in a batch by loading the next index table from the disk array 550 as the current index table is being utilized. Although the hash calculation on the search terms can optionally be accelerated by the index processing device 516, the processing of the index table may be completed via software and/or hardware as desired.

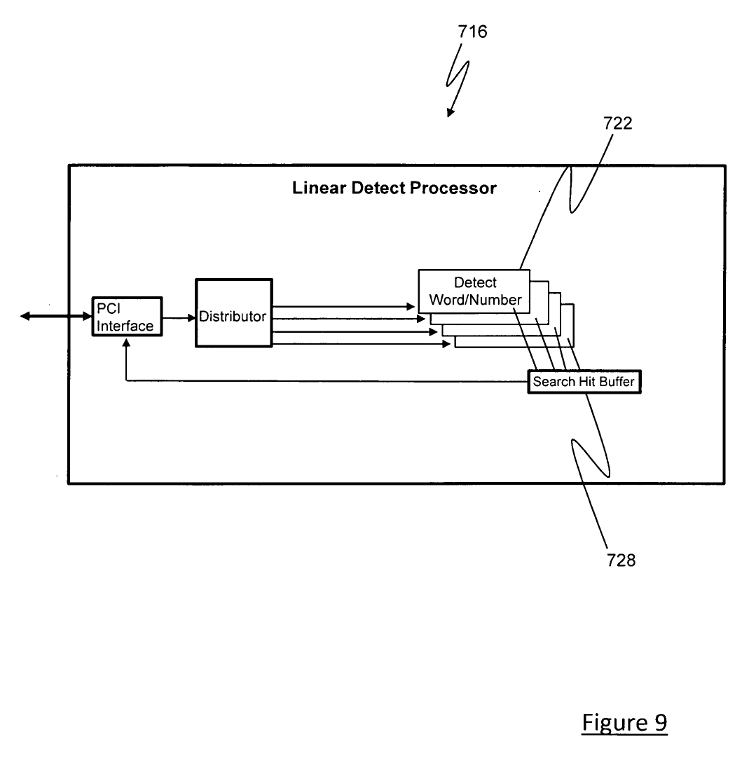

It should be appreciated that the system described herein can also support linear searching or match detection of either the word references or of the file data. This linear search capability basically mimics the old way document discovery was completed in which a person was given a list of search terms and a pile of documents and told to read over the documents looking for the search terms and identify the document, location, and what they found. For example, in linear searching the user may know up front what they are looking for and as such, linear searching allows the searching software/hardware to be aggressive in finding exactly what the user is looking for. This can be helpful if the user is looking for abbreviations or numbers which, depending upon where they are and how they are formatted, may or may not end up being detected. As such, index processing device 716 may be configured as shown in FIG. 9 to implement linear searching at substantially faster speeds than conventional CPUs. This may be beneficial because when using a conventional CPU for linear searching, the speed of the search would slow down linearly as the number of search terms increases. For example, searching for a single term with a fuzzy match could take close to 10 ns per character, making the maximum search rate about 100 MB/sec (if a hundred terms were searched, the search time would slow to about 1 MB/sec), where using linear processing device 716, a fuzzy search can be implemented on up to a hundred terms simultaneously and maintain an overall processing rate of 100 MB/sec (a hundred fold speed increase).

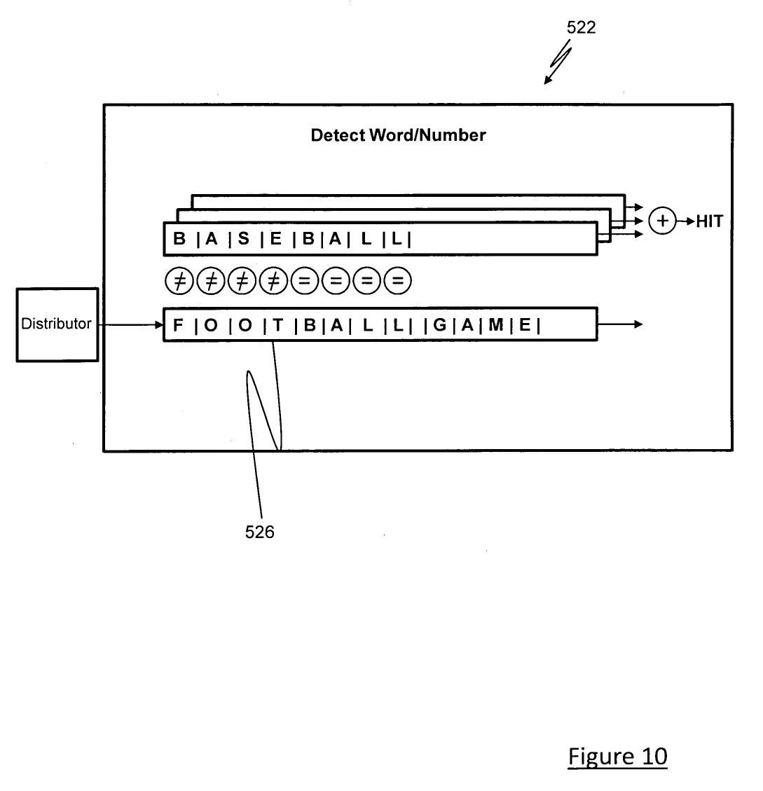

Moreover, it is contemplated that the detect processor 722 may perform a linear search of the incoming stream of word references by attempting either a hard or a fuzzy match against definable search terms, which can be either words, phrases, and/or numbers. In a preferred embodiment, multiple detect processors 722 can be utilized (in parallel and/or series) where each may be capable of detecting multiple search terms. For example, if each of the multiple detect processors 722 are configured to detect 16 search terms, this would allow for up to 256 search terms to be processed if 16 detect processors are implemented. Each can handle a character per clock cycle allowing searches at greater than 100 MB/sec. If linear search terms are supplied, then the incoming characters may be continually and simultaneously compared to each of the search terms and when a hit occurs, the term identification and the location of the hit may be stored in a search buffer 728 to await transfer to the host computer. This process is demonstrated in FIG. 10 with the words “FOOTBALL GAME”. It is contemplated that the linear searching processing device 716 may include internal memory to hold and buffer the hit or references in an organized manner.

It should be appreciated that the method described herein can either be applied on the word references that are found and have been previously stored as a result of finding what is considered words in a volume of file data and/or it can be applied against raw file or data stream input. In the case of raw file or data stream input the candidate words may be broken apart by looking for any character that is not in the search terms character set. The fragments of data that match the character set may then be compared against the search terms in a very similar way to how word references are processed. This method of simply splitting up words is different than attempting to isolate valid words. As a result this method will accept many more character sequences for processing as there is really no cost involved in processing random fragments versus the case of the word finder where everything considered a word must be stored therefore invoking some cost.

Additionally, the hardware system disclosed herein can also implement a high performance file level deduper which may in turn utilize the hardware index processing device 516 in a different mode. In this case, the index processing device 516 may be configured to serve as a Secure Hash Algorithm (SHA) hash calculation engine, where the deduper can process about 500 MB/sec (or more) and generate a result file that can be transferred to the processing system to avoid processing duplicate data files. Alternatively, the deduper can be run standalone to simply provide deduped data. Accordingly, the present invention can be utilized for deduping, indexing and/or linear searching, where the system utilizes a balanced combination of efficient software and hardware. The system is balanced to prevent processing bottlenecks that can seriously limit its performance as it relieves the host machines main processors and the memory subsystems from being tied up with processing. The CPU can instead efficiently handle I/O, file analysis, decompression, specialized file handling or conversion, and result management with minimal latency keeping the data flowing smoothly.

Referring again to FIG. 9, the linear search detect processor 716 may be a hardware implemented system that is configured to accept a stream of words and compare each word against a large group of search words to detect a match. This may be accomplished by having multiple search detect processors 722 where each may be capable of searching for multiple words. The relationship between the multiple search detect processors 722 and the multiple words allows a scalable system to be built that can compare the input word against hundreds (or more) of search terms very quickly, typically within several processor clock cycles. Doing this same task with a conventional general purpose CPU would also take several clock cycles per word, but this execution time would have to multiplied by the number of search terms. As a result, a conventional CPU even running at a significantly faster clock rate would take an order of magnitude or more execution time to achieve the same result.

The comparison does not have to be exact and can be what is referred to as fuzzy meaning that even if the word you are searching for contains minor spelling or typographical mistakes the word can still be accepted as a match. How strict or forgiving the matching process is can be parameterized as desired, such as on a per word basis. This is helpful as some less common words may, with just a single letter change, match a very common word which you would not want to allow as an acceptable result.

In accordance with the invention, linear search detect processor 716 may be configured to frame the word. It should be noted that the word may already have been framed and stored as the word reference as described hereinabove. However, if the data being processed is a file or stream of data then the words must be located. In general, a simpler algorithm can be used than what is described hereinabove as there is no resource cost presenting this processor with arbitrary character sequences that may not be real words. The algorithm can simply take and group letters or numbers delimited by any character that is not a letter or number and frame them as a word. Character normalization would still apply and as a result the UTF-8 and UTF-16 decoders would still be needed. The word may then be translated from the 16 bit normalized character codes for the letters/numbers to 8 bits as most languages can represent the full set of upper case letters and numbers within 256 codes. At this point, the framed candidate word is introduced into each core or instance of the search detect processor 716, where each core may be thought of as a search engine. Depending on the amount of fabric available in the linear search detect processor 716, anywhere from 8 to as many as 256 search engines may be implemented. More search engines do not really speed processing but they do allow for a greater number of search words. Each search engine may be loaded with 8 to 32 search words and the parameterization that may accompany each search word.

The beginning (first 4-6 characters) of each search word in each engine is compared against the beginning of the candidate word. This comparison may be performed on a wide variety of different combinations as described below to allow for minor spelling and typographical errors. This comparison results in the possibility of finding no matches or one or more matches. If no match is identified, than there is no match to any search term and the processing of the candidate word by this engine is complete. If only one match is identified than the candidate word and the search term that has demonstrated an initial match now must be further considered. If more than one match is identified, this creates an exception that indicates that further handling by the search engine is not possible. The candidate word and engine instance are recorded in the exception and the exception information is returned to the host computer that will then use a slower software algorithm similar to what is described herein to handle the multiple match situation. In general, if the search terms fed into each search engine are dissimilar from each other in the first 6 characters then multiple matches and the exceptions they would generate should be rare. If similar words exist in the overall group of search terms, then the similar words should be divided between different search engines to avoid this potential problem.

As an example, consider the situation where fourteen character comparisons are performed as detailed in Table 1-1. The comparator compares the designated character in the Search term with the designated character in the candidate word. Each comparison is given a letter designation and CP in the table below means Character Position within the word. These fourteen comparison results are combined in groups (See Table 1-2) to determine a match. Each of the groups considers four of the comparisons from Table 1-1, where three out of the four comparisons must be true for the candidate word and the search term to be considered a match. The results of the combinations can also be used to determine the starting character in the candidate word as it is possible that the word framing may have included extra bytes which became characters at the beginning of the word that do not belong to the intended word.

TABLE 1-1

| Comparison | CP Search Term | CP Candidate Word |
|---|---|---|
| A | 1 | 1 |
| B | 2 | 2 |
| C | 3 | 3 |
| D | 4 | 4 |
| E | 2 | 3 |
| F | 3 | 4 |
| G | 4 | 5 |
| H | 3 | 2 |
| I | 4 | 3 |
| J | 1 | 2 |
| K | 1 | 3 |
| L | 2 | 4 |
| M | 3 | 5 |
| N | 4 | 6 |

TABLE 1-2

| Comparisons | Starting Char |
|---|---|
| ABCD | 1 |
| AEFG | 1 |
| ABFG | 1 |
| ABCG | 1 |
| ABHI | 1 |
| ABCI | 1 |
| JEFG | 2 |
| KLMN | 3 |
| JLMN | 2 |
| JEMN | 2 |
| JEFN | 2 |
| JECD | 2 |
| KLFG | 3 |

Assuming that a match is found, we go to the next step. It should be appreciated that the other engines are acting independently of this engine and they may have different outcomes. Once an initial match candidate is detected then a more advanced analysis may be performed to determine if the candidate word is a close enough match to the chosen search term. This involves reading a character attribute pair (such as from high speed on chip memory) for each character in the search word, where the character is the proper character to match. The attributes determine if a substitute character is allowed but can also exclude a limited number of substitutes that would result in the creation of a different common word. Likewise attributes can determine if an extra character is allowed again excluding a limited number of substitutes that if added would result in a different common word. An attribute can also indicate if skipping this character would be allowed or if doing this would also result in a different common word. The analysis to create these attributes may be performed (after the search term has been received) in software using a process of trying all the possible letter substitutions, adding characters, and skipping characters combinations and then referring the results of each trial against a dictionary of common language specific words. If its hits this dictionary then that substitution may be set to not be allowed.

If the single letter comparisons all succeed inclusive of the substitutions allowed by the attributes, then a check may be performed to ensure that the number of substitutions that were accepted in each category and in total does not exceed the parameters on the limits for this word. Generally, longer words may allow for more substitutions while shorter words would probably only allow a total of one substitutions. A fully successful comparison results in the candidate word along with its location, the search engine index, and the search term index being fed back to the host computer. This information will then be used either for further algorithmic analysis if desired or properly stored for evaluation of phrase comparison as described herein. It should be appreciated that the method as disclosed herein may be applied to a stream of data wherein the stream of data may be logically divided into data files.

It should be appreciated that number(s) may be handled in a significantly different manner as they can either be compared against a search number just like a word is compared against a search word, and/or a search can be done for part of a number (like a certain area code), and/or a search can be done for the integer portion of the number being between a low and high limit. In the case of the last two alternatives, this may require a different type of search engine capable of this different functionality. Since numbers tend to be much less frequent than words the numbers may go into a different queue within the distributor and only a small number of these numeric search engines may be implemented, for example typically a quarter of the word search engines that are implemented in the fabric. It should also be appreciated that the invention can be used with data and/or a data file that has words in multiple natural constructed languages (e.g. English, French, Russian, etc). In this case, the word(s) may be handled on a word by word basis, or the data/data file may be handled separately for each language.

Moreover, the performance may be dependent on the implementation of this design. But in what is envisioned it may be implemented as logic in a modern FPGA, the first and second parts of this process can be pipelined and as a result may have no real effect on the performance as they can be accomplished faster than the third and fourth parts of this process. The third part may access the search words from fast on chip memory and it can access up to 72 bits of information in a single clock cycle which represents the first four characters of two search terms. In one embodiment, the two search terms read from memory can be processed simultaneously and in a single clock cycle in each search engine. For example, if 16 search terms are loaded, the comparisons and results could be obtained in eight clock cycles. Since the average non-trivial word is about eight characters it results in an average performance of a character per clock cycle. If one of the search terms is a match then the search engine may enter a different mode where it may implement what is described in the fourth part of this process. This may involve fetching a 72 bit word (character plus attributes) for each character in the chosen search term and performing the necessary comparisons. Accordingly, a character could be processed on each clock cycle leading to an average of eight clock cycles for the average eight character word.

These extra eight clock cycles may not however double the average time needed per character/word as these extra eight clock cycles may only be used by those search engines that have a match on a search term from the third part. This will typically only be a few percent of the search engines as a result the average number of clock cycles added per word will be less than two. It should be appreciated that every input word may be introduced to each of the search engines so that each of the search engines can operate in parallel. According, each of the search engines will ‘see’ the same word set that the other search engines ‘see’. Since the matches in the third part may tend to load balance between search engines especially if the common words used as search terms are well distributed, no one search engine should significantly slow the processing in most cases. Although there may be situations where the distributor's queue fills and the processing has to be suspended on all the remaining search engines to allow a search engine with extensive backlog to catch up. The number of search engines is really only limited by the amount of silicon fabric that is available. Although 16 search terms per search engine is a preferred embodiment, more or less that 16 search terms per search engine may be introduced. If there are more search terms that can be set into the available search engines then the search terms can be broken into two or more groups and the input data buffered into reasonably large blocks (several hundred megabytes) the search engines may then be setup for the first group and presented the buffer's data. When complete the second group of search terms may be set into the search engine and the buffer of data will be processed again. This may continue until all the groups of search terms have been used. Then a new buffer of data may be loaded and processed in the same manner. This does slow the processing by the number of groups of search terms. In many situations though the needed search terms can fit into the available search engines thereby not requiring this.

In accordance with the present invention, an overall process of finding words within arbitrary computer files without knowledge of the file format, structure and/or layout of the computer files or the words being searched for (i.e. search terms) is provided. Existing methods of searching for words either require that the characteristics of the words being searched for be known or that where the words were located be known so that all of the words within these segments of the file could be collected and stored usually in an indexed manner for future searching once search terms were established. Not requiring one of these two conditions lowers the complexity of the system, improves the flexibility, and in general improves the accuracy. Any efficiency lost as many terms may get stored that are not really words in the context of the file format may be compensated for through hardware implementation of the searching function.

The storage and indexing provided herein technique is targeted at the words found in files it could be used for other applications where a large amount of references are generated rapidly. There are several notable points to this technique as follows:
The technique used to create multiple hashes and thereby indexes for a word to allow for a match even if there is a spelling or typographical error in the word.
The partial indexing solution where a portion of the index selects the sub-table and then the remaining portion is stored in the index entry allowing a search to quickly select the sub-table and then a high performance linear search can be performed for the element within the sub-table. This architecture creates the environment for the efficiency, simplicity, performance, and scalability described in the points below.
The many to one association where the multiple indexes to a word can be efficiently stored in a 32 bit value pointing to a single much larger word reference.
The efficiency of the reference and index storage technique that optimizes memory usage important as high speed SRAM is quite expensive.
The simplicity of the technique as it does not require any complex memory management and uses fixed bit width elements this lends itself to a realizable hardware implementation of the storage and management algorithm.
The scalability of the technique in that the small tables maintained in fast SRAM can be efficiently merged with larger tables of the same structure in the main memory of the host computer. These larger tables can be quickly saved out to disk in a linear fashion as unmodified images of the table allowing them to be quickly saved to disk and loaded back in and utilized during the searching phase of the process.
The performance of the process in that most of the small random (non-sequential) memory accesses happen within the fast SRAM connected to the Word Finder processor where no performance penalty has to be paid for a random memory access. Once the small tables in SRAM fill they are transferred into the host computers main memory in a manner that minimizes the number of random memory accesses needed. With typical data less than 2% of the memory access to main memory would be random, dramatically optimizing the performance of populating main memory tables as there is a heavy performance penalty associated with random memory accesses to host computer main memory.

As disclosed is a hardware based linear searching technique which is unique in that the concept involves multiple fuzzy (not exact match) searches that can be implemented in a hardware based match detection processor. This implementation will dramatically speed up these types of searches from what is possible with a general purpose CPU. The implementation of this technique combines logic in the gate array with small blocks of very fast access storage located on chip to achieve an implementation that is efficient in both space amount of fabric used and time. The existence of this processing capability creates an environment where indexed searching the main-stay for searching large volumes of data is not necessary as the data or a recognized subset of it (like the words found by the word finder) can be searched for multiple fuzzy search terms at a rate that compares well with the speed that the data can be read from disk storage. This also minimizes the complexities and inefficiencies involved in indexing. Moreover, it should be appreciated that processing can be conducted on files or data streams that have been logically divided into sections that represent files. A data stream may come from a networking device or from a wide variety of telecommunications devices. Where the term file or data file is used herein, it can also refer to the possibility of this file or data file being an appropriate logical section of a data stream.

Moreover, each of the elements of the present invention may be implemented in part, or in whole, in any order suitable to the desired end purpose. In accordance with an exemplary embodiment, the processing required to practice the method of the present invention, either in whole or in part, may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. It should also be appreciated that the embodiments disclosed herein are for illustrative purposes only and include only some of the possible embodiments contemplated by the present invention.

Furthermore, the invention may be wholly or partially embodied in the form of a computer system or controller implemented processes. It should be appreciated that any type of computer system (as is well known in the art) and/or gaming system may be used and that the invention may be implemented via any type of network setup, including but not limited to a LAN and/or a WAN (wired or wireless). The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A method for processing a plurality of data to identify and search words contained with said plurality of data, wherein knowledge of the data format is unknown, the method comprising:
identifying words within said data, wherein said indentifying includes,
processing said data to identify words, prior to searching; and
storing said words in a predetermined manner;
and,
searching said words, wherein said searching includes,
searching said words responsive to at least one search term to identify match results, and
processing said match results to at least one of save said match results to a file and display said match results.

2. The method of claim 1, wherein said identifying further includes determining a natural constructed language of at least a portion of said data.

3. The method of claim 1, wherein said identifying further includes at least one of,
determining character encodings of said data, and
determining a location of a word group within said data.

4. The method of claim 1, wherein said identifying further includes,
examining at least a portion of said data to determine data file type; and
determining whether said data requires special handling responsive to said data file type.

5. The method of claim 1, wherein said identifying further includes determining a first set of processing parameters for said data.

6. The method of claim 5, further comprising:
determining if said first set of processing parameters produce satisfactory results;
wherein if said first set of processing parameters does not produce satisfactory results,
determining whether a second set of processing parameters exists which does produce satisfactory results.

7. The method of claim 6, wherein said determine whether a second set of processing parameters exists includes conducting at least one of,
an examination of said data to look for sections of text and the language of said text, and
an examination of entropy of said data to determine if all or part of said data is compressed data or image data.

8. The method of claim 1, wherein said identifying further includes,
associating identified words with a word reference.

9. The method of claim 1, wherein said storing includes storing said words via at least one of a linear storage method and an indexed storage method.

10. The method of claim 1, wherein said searching includes searching said words responsive to said storing, wherein
if said words were stored using a linear storage method, said searching is conducted using a linear search method; and
if said words were stored using an indexed storage method, said searching is conducted using an indexed search method.

11. A method for indentifying words contained within a plurality of data, wherein knowledge of the data format is unknown, the method comprising:
determining a natural constructed language of at least a portion of said data;
processing said data responsive to said natural language to identify words contained within said data, prior to searching; and
storing said words using at least one of a linear storage method and an indexed storage method.

12. The method of claim 11, further comprising at least one of,
determining character encodings of said data, and
determining a location of a word group within said data.

13. The method of claim 11, further comprising,
examining at least a portion of said data to determine data file type; and
determining whether said data requires special handling responsive to said data file type.

14. The method of claim 11, further comprising,
associating said words with a word reference.

15. A method for searching identified words contained within a plurality of data, wherein knowledge of the data format is unknown, the method comprising:
receiving at least one search term;
searching said words responsive to said at least one search term to identify match results, wherein said searching is conducted via multiple search engines configured to conduct an exact or fuzzy search of said words in parallel, and
processing said match results to at least one of save said match results to a file and display said match results.

16. The method of claim 15, wherein said searching includes searching said identified words responsive to how said identified words were stored, wherein
if said words were stored using a linear storage method, said searching is conducted using a linear search method; and
if said words were stored using an indexed storage method, said searching is conducted using an indexed search method.

17. A system for implementing a method for searching and indexing a plurality of data contained within a data file, the system comprising:
a means for receiving the data file;
a means for storing the data file; and
a means for implementing a method for processing a plurality of data to identify and search words contained with said plurality of data, wherein knowledge of the data format is unknown, the method comprising:
identifying words within said data, wherein said indentifying includes,
processing said data to identify words, prior to searching; and
storing said words in a predetermined manner;
and,
searching said words, wherein said searching includes,
searching said words responsive to at least one search term to identify match results, and
processing said match results to at least one of save said match results to a file and display said match results.

18. A computer readable storage medium having computer executable instructions for implementing a method for processing a plurality of data to identify and search words contained with said plurality of data, wherein knowledge of the data format is unknown, the method comprising:
identifying words within said data, wherein said indentifying includes,
processing said data to identify words, prior to searching; and
storing said words in a predetermined manner;
and,
searching said words, wherein said searching includes,
searching said words responsive to at least one search term to identify match results, and
processing said match results to at least one of save said match results to a file and display said match results.

19. A system for identifying and searching words contained with a plurality of data, wherein knowledge of the data format is unknown, the system comprising:
an input device;
a memory device;
an index processing device;
a processing device in signal communication with said input device and said memory device; and
an index processor coupled to said memory device,
wherein said processing device is configured to
receive data,
distribute said data to a processor,
identify a word in the content of said data using said processor,
generate a word reference by recording a location of said word,
calculate a hash value for said word reference,
store said word reference in a structured manner using said hash value,
transfer said reference and said hash value to at least one table in said memory;
search said words responsive to at least one search term to identify match results, and
process said match results to at least one of save said match results to a file and display said match results

20. A search and indexing system comprising:
a data reader configured to read data;
a data processor coupled to said data reader, said data processor configured to determine content of said data;
an index processor coupled to said data processor and configured to index said data, said index processor including a search/detect processor configured to detect a word in said data and to create a hash value from said word; and
a memory coupled to said index processor, wherein a word reference is generated responsive to said word and stored in said memory, said memory being configured to transfer said word reference and said hash value to a table.
